(19) United States
(12) Patent Application Publication
(10) Pub. No.: US 2015/0139001 A1
(43) Pub. Date: May 21, 2015

(54) METHOD AND APPARATUS FOR BEAM IDENTIFICATION IN MULTI-ANTENNA SYSTEMS

(71) Applicants: Feng Xue, Redwood City, CA (US); Qinghua Li, San Ramon, CA (US); Yuan Zhu, Beijing (CN)

(72) Inventors: Feng Xue, Redwood City, CA (US); Qinghua Li, San Ramon, CA (US); Yuan Zhu, Beijing (CN)

(21) Appl. No.: 14/368,206

(22) PCT Filed: Nov. 20, 2013
(86) PCT No.: PCT/US2013/070998

§ 371 Date: Jun. 23, 2014

(51) Int. Cl. H04L 5/00; H04W 24/08; H04W 72/04

(52) U.S. Cl. CPC H04L 5/0057; H04W 72/0413; H04W 24/08; H04L 5/0048; H04W 72/042; H04W 72/046; H04W 88/02
USPC 370/252; 370/329

(57) ABSTRACT

Embodiments allow a station to determine which of a plurality of spatial beams is best suited for communicating with user equipment (UE). Some embodiments overlay spatial multiplexing in a way that provides support for UE without changing existing signaling schemes. In these embodiments, different messages, each designed to provoke different behavior in the UE, are transmitted on different spatial beams. The station then observes the behavior to determine which beam is most suited for the UE. Other embodiments design new signaling schemes to effectively allow UE supporting the schemes to identify which beam is most suited for communication. A single reference signal is scrambled with one of a plurality of indexing sequences, and each is transmitted on a different spatial beam. The UE performs a channel quality estimate for each scrambled signal and determines the index best suited for communication. The index may then be transmitted to the station.

### TECHNICAL FIELD

Embodiments pertain to multi-antenna wireless communications. More particularly, some embodiments relate to identifying which beam of a multi-beam transmitter a receiver resides in.

### BACKGROUND

Communication systems can have a variety of parameters and features to separate transmissions for multiple receivers and/or to increase transmission bandwidth. For example, a transmitter with multiple antennas may form multiple, spatially separated beams and transmit to multiple receivers located in different beams. To maximize the effectiveness of such a system, it is often desirable to know which beam a particular receiver resides in.

### BRIEF DESCRIPTION OF THE DRAWINGS

FIG. 1 illustrates an example wireless network with a transmitter having multiple beams.

FIG. 2 illustrates an example system with spatial multiplexing.

FIG. 3 illustrates an example of resource allocations used in a representative spatial multiplexing system.

FIG. 4 illustrates an example flow diagram of a system using spatial multiplexing.

FIG. 5 illustrates an example system with spatial multiplexing.

FIG. 6 illustrates an example flow diagram of a system using spatial multiplexing.

FIG. 7 illustrates a system block diagram according to some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Various modifications to the embodiments will be readily apparent to those skilled in the art, and the generic principles defined herein may be applied to other embodiments and applications without departing from the scope of the disclosure. Moreover, in the following description, numerous details are set forth for the purpose of explanation. However, one of ordinary skill in the art will realize that embodiments disclosed herein may be practiced without the use of these specific details. In other instances, well-known structures and processes are not shown in block diagram form in order not to obscure the description of the embodiments of disclosed herein with unnecessary detail. Thus, the present disclosure is not intended to be limited to the embodiments shown, but is to be accorded the widest scope consistent with the principles and features disclosed herein.

Although the embodiments of this disclosure will generally be discussed in terms of UE and other devices that adhere to the LTE standard, the principles herein may be applied to UE and other devices outside of the LTE standard. For example, an embodiment may mention that a UE has channels called PDCCH, DCI, etc. In other systems, devices also have control channels, but they might have different names and the principles discussed herein may be applied to the devices in other systems by using the appropriate control channel(s), even though they are called by a different name.

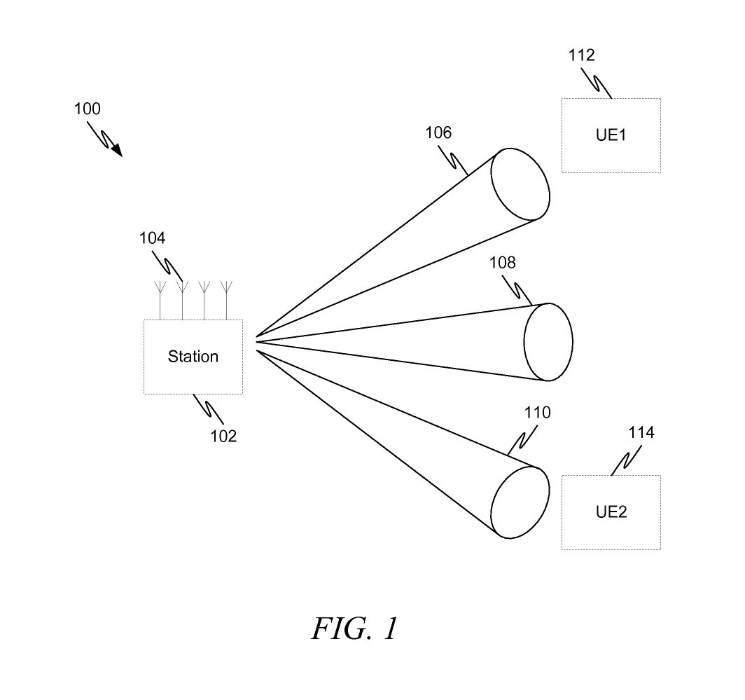

FIG. 1 illustrates an example wireless network 100 with a station 102 able to produce multiple spatial beams. In such a wireless communications network 100, a station with multiple antennas 104 can establish multiple beams to cover its communication area. For example, in the context of wireless communications such as mobile cellular, station 102 may represent an enhanced Node B (eNB) with multiple antennas that may be used to create multiple spatial beams, each suitable for a particular User Equipment (UE) such as UE 112 and UE 114, or a particular group of UE when multiple UE reside in the same spatial beam. As the number of antennas increases, such spatial multiplexing can be made more and more ‘sharp’ in the sense that the spatial beams may be tapered more quickly so they do not cause much interference to each other, at least in the center of coverage. This is one of the basic advantages of using more antennas. As used herein, the process of forming multiple spatial beams to communicate with various UEs will be referred to as spatial multiplexing.

To make spatial multiplexing work in practice, one of the key challenges is how the transmitter knows which beam is suitable for which UE. This is because several beams will be active on the same set of time-frequency resources. Thus, station 102 may employ various mechanisms to determine that the UE 112 is located in spatial beam 106 and the UE 114 is located in spatial beam 110. After the station 102 determines which beam is suitable for communicating with which UE, the station 102 may send information-bearing signals on the correct spatial beam towards the desired UE.

In the context of Universal Mobile Telecommunication System (UMTS) Long Term Evolution (LTE) and other similar cellular systems, standards evolve over time to include newer and more efficient communication schemes, such as the spatial multiplexing system illustrated in FIG. 1. As standards evolve, support for current UEs and future UEs are typically dealt with differently as new signaling methodologies consistent with this disclosure generally cannot be required for current UEs. Thus, implementations of the spatial multiplexing systems discussed herein may identify different mechanisms, some of which may support both current UEs and future UEs and some of which may support only one or the other.

Returning to FIG. 1, if station 102 has M antennas, a set of precoding matrices F, may be designed to form L beams, with each matrix having a dimension of M×N. Thus, if station 102 has 10 antennas (M=10) and the number of beams, L, is 6 as illustrated in FIG. 1, the set of precoding matrices F={F₁, F₂, F₃, F₄, F₅, F₆}, each matrix would be 10×4, if N is chosen to be 4. The transmit signal X would be of the form:

X=Σₖ₌₁^{L}FₖB_{Uk}X_{Uk}

Where:
Fₖ is the k^{th} precoding matrix that generates the k^{th} beam,
B_{Uk} is the code book specific to the Uk UE, and
X_{Uk} is the data signal specific to the Uk UE.

Given a sufficient number of antennas, F may be designed so that each precoding matrix, Fₖ, produces beams that cover mutually exclusive space (e.g., in the boundary area between beams, the Signal to Interference plus Noise Ratio (SINR) could be low). The design of precoding matrices to produce these results are well known in the art and need not be reproduced here.

If the station 102 desires to send a reference signal such as a Cell Specific Reference (CRS), Demodulation Reference Signal (DM-RS), Channel State Information Reference Signal (CSR-RS), and the like, B_{Uk}X_{Uk} above may be replaced with the appropriate reference signal, Sₖ.

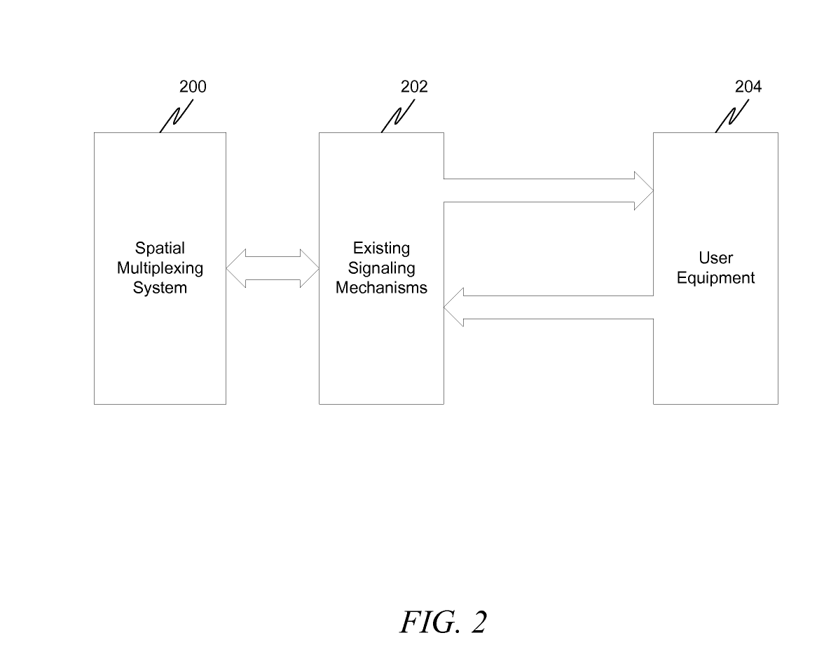

FIG. 2 illustrates an example system with spatial multiplexing. In this system, a spatial multiplexing system 200 prepares a signal of the appropriate format and then uses existing signaling mechanisms 202 to transmit the constructed signal using multiple spatial beams. Based on information received from UE 204, the spatial multiplexing system 200 is able to determine in which beam UE 204 resides.

At a high level, spatial multiplexing system 200 constructs a signal of the form:

X=Σₖ₌₁^{L}FₖMₖ

Where:
Fₖ is the k^{th} precoding matrix that generates the k^{th} beam
Mₖ is a message, that if responded to by the UE will be detectable to the spatial multiplexing system.

Thus, message Mₖ is transmitted on the k^{th} spatial beam. In order to distinguish between beams, Mₖ is selected so that each message, if responded to, will provoke behavior in the UE that allows the spatial multiplexing system 200 to identify which message was responded to by the UE. As one example, each Mₖ may direct UE 204 to respond at a different time, on a different frequency, with different content, or any combination thereof. As long as the message Mₖ complies with the desired standard, the entire spatial multiplexing system will be transparent to the UE, and the UE will be able to operate as if it were communicating with an eNB or other station without spatial multiplexing. As long as the message Mₖ will provoke behavior that is distinguishable from all other messages M₁, the spatial multiplexing system will be able to identify in which beam the UE 204 resides. In essence, the spatial multiplexing aspect is overlaid on existing behavior in such a way that which beam the UE resides in may be identified.

Taking LTE-Release 8 as an example, an eNB allocates uplink channels to each UE in its coverage area. In LTE Release 8, an eNB may use a Downlink Control Information (DCI) message transmitted on a Physical Downlink Control CHannel (PDCCH) to allocate uplink channels (Physical Uplink Shared CHannel—PUSCH) to a particular UE. This message exchange mechanism may be used to identify which beam a UE resides in by a system of the type illustrated in FIG. 2. Other message exchange mechanisms may also be used.

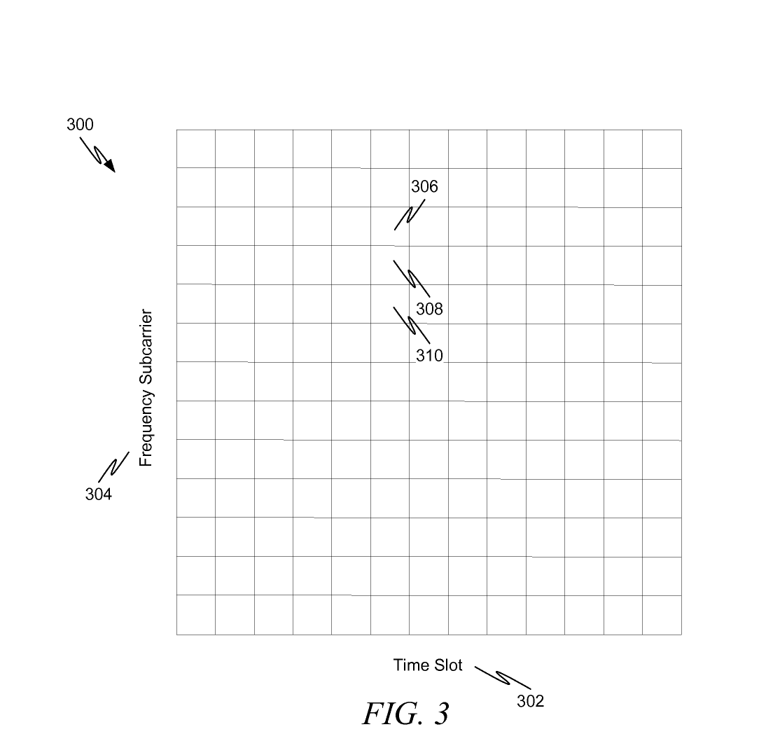

FIG. 3 illustrates an example of resource allocations used in a representative spatial multiplexing system. Time slots 302 and frequency subcarriers 304 may be placed in a time-frequency matrix 300. Resource allocations (e.g., 306, 308, 310) then represent communication opportunities that may be allocated in accordance with the principles of whatever standard is being used. For example, FIG. 3 may represent opportunities that may be allocated to a particular UE in accordance with the LTE standard. If FIG. 3 represents the opportunities for uplink that may be allocated to a UE, then a spatial multiplexing system may allocate independent, non-overlapping allocations (such as 306, 308, 310, etc.) as potential uplink opportunities to a UE so that the spatial multiplexing system may determine the best spatial beam to communicate with the UE.

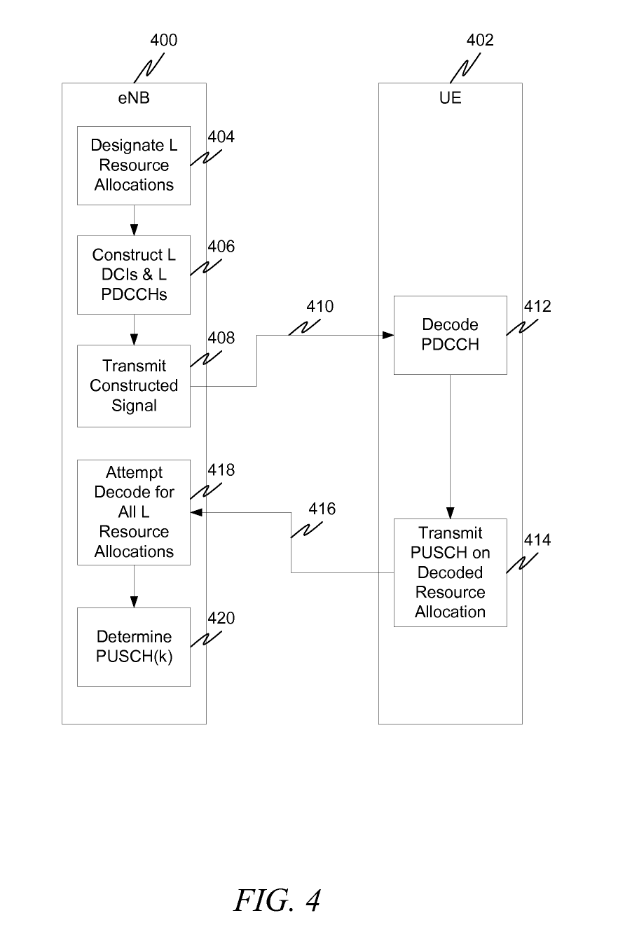

FIG. 4 illustrates an example flow diagram of a system using spatial multiplexing. In this representative example, the system uses the behavior described above in conjunction with LTE Release 8 to identify which beam should be used to communicate with a particular UE. In particular, the system uses allocation of uplink slots via PDCCH to identify the appropriate beam.

In FIG. 4, an eNB 400 first allocates L resource allocations for potential uplink slots for a UE 402 designed by a Cell-specific Radio Network Temporary Identifier (C-RNTI). The resource allocations should be allocated so as to be non-overlapping. Non-overlapping means that should the UE 402 respond on a particular allocated resource allocation, the eNB 400 will be able to determine that the UE 402 responded on that particular allocated resource rather than one of the other allocated resources. Operation 404 illustrates this process.

Once the resource allocations have been allocated, the eNB 400 constructs L different DCI messages to be transmitted using L different PDCCHs. Each of the L different DCI messages tells the UE 402 to use a different one of the L allocated resource allocations. Operation 406 illustrates this process. Each of the PDCCH is encoded with an identity unique to UE 402 (e.g. the C-RNTI) so that other UE that may receive the PDCCH will not respond.

The constructed messages will each be transmitted using a different spatial beam. Thus, the transmitted messages may be thought of as having the form:

X=Σₖ₌₁^{L}FₖPDCCHₖ

Where:
Fₖ is the k^{th} precoding matrix that generates the k^{th} beam PDCCHₖ is the k^{th} PDCCH containing the k^{th} DCI which allocates the k^{th} resource allocation to UE 402.

The eNB 400 then constructs an appropriate signal (operation 408) and transmits it (operation 410). The transmission signal has the same form as that listed above, except the physical modulated form of PDCCHₖ is substituted for PDCCHₖ.

The above process results in a different allocated uplink opportunity being transmitted to the UE 402 on a different spatial beam. Since the UE 402 physically resides in a particular spatial location, the PDCCH transmitted on one beam will be detectable by the UE 402, while the others will not be detectable. The worst case scenario where the UE 402 resides between two beams and can decode neither correctly will be addressed below.

In operation 412, the UE 402 decodes the PDCCH of the beam where it resides. The UE 402 thus transmits on the allocated PUSCH, as indicated in operations 414 and 416.

Since the eNB 400 does not know which of the allocated resource allocations will be used by the UE 402, the eNB 400 attempts decoding of the appropriate PUSCH on each of the allocated resource allocations to identify which allocated resource allocation, if any, the UE 402 is using to communicate back to the eNB. Operation 418 indicates this process.

The UE 402 will have communicated on one of the allocated resource allocations. Once the eNB 400 identifies which allocated resource allocation is being used, the eNB 400 may determine which beam is most appropriate to communicate to the UE 402 by correlating which beam was used to send the allocated resource allocation to the UE 402.

Although a small probability, the UE 402 may reside in a spatial location between two beams so that information transmitted on either beam will not be received and decoded correctly. In this situation, UE 402 will not transmit on any of the allocated resource allocations for the simple reason that it never received the message allocating the resource allocations or it was unable to successfully decode the message. In this situation, the very fact that the UE 402 did not transmit according to any of the allocated resource allocations is an indication that the UE 402 may be located in a location where it is unable to receive one of the spatial beams. In this situation, the eNB 400 may decide to wait and try again, may decide to take other remedial action, or some combination thereof. For example, the eNB 400 may select other precoding matrices Fₖ that relocate the beams spatially so that UE 402 may no longer reside between two beams.

Finally, with respect to FIGS. 2, 3, and 4, it is possible to design the method to either perform the detection “in parallel” or “serially.” By selecting mutually exclusive resource allocations such that they are “close” in time and/or frequency, it may limit the amount of time the eNB 400 uses to search for replies from UE 402 before the eNB 400 determines which beam is most suitable for communication with UE 402. This can occur, for example, when the same time slot and/or close frequency subcarriers are used. Additionally, all the PDCCHₖ may be transmitted on all beams simultaneously (e.g., at the same time slot). However, depending on resource utilization, the eNB 400 may also carry out a more serial search where resources are allocated in a more “stretched out” format and/or PDCCHₖ may be transmitted on different beams on different communication slots so that the transmission of PDCCHₖ is spread over a larger time period.

Since any future UE may support the same signaling mechanisms as the current UE, the method described above in conjunction with FIGS. 2, 3, and 4 may also work with future UEs. However, future UEs may be designed to support new signaling mechanisms that increase the effectiveness of methods used to locate a UE by taking advantage of new such signaling mechanisms.

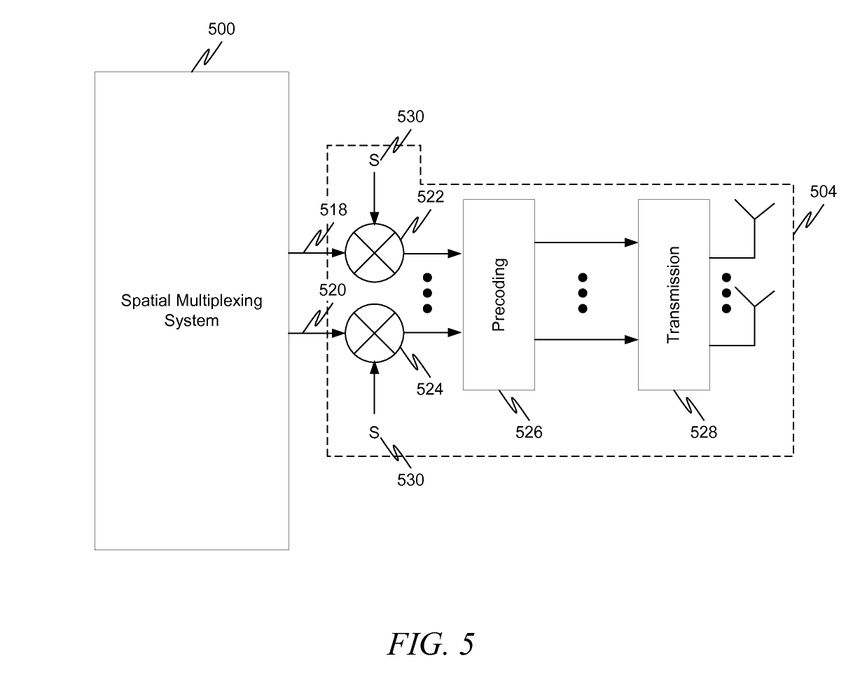

FIG. 5 illustrates an example system with spatial multiplexing, where different signaling mechanisms may be used. Such an example system may comprise spatial multiplexing system 500 and signaling mechanisms 504 that are designed to use signaling schemes that change the currently supported standard control and reference signal interfaces in LTE/LTE-A. This signaling scheme comprises a new reference signal structure that consists of a plurality of spatially separate reference signals. The system may generate the spatially separate reference, for example, by taking a reference signal and modifying it by an indexing sequence.

In one example, suppose an existing reference signal structure is transmitted on resource allocation B. One example would be the CSI-RS defined in the LTE Release 9 or later. However, this approach holds true for other reference signals as well. In the signaling mechanism of FIG. 5, a reference signal S is shown as 530, where S represents the bit sequence of the reference signal before modulation. This represents the reference signal that will be transmitted on resource allocation B. Spatial multiplexing system 500 may then generate L indexing sequences (one to be used for each beam) such that the system may create a signal of the form:

X=Σₖ₌₁^{L}Fₖf(S+Iₖ)

Where:
Fₖ is the k^{th} precoding matrix that generates the k^{th} beam,
S is the bit sequence for the reference signal,
Iₖ is the k^{th} indexing sequence, and
f( ) is the modulation process for the physical signal of the reference signal.

In FIG. 5, the output (e.g., 518, 520) of the spatial multiplexing system 500 may represent the various indexing sequences, Iₖ. Although only two sequences are shown, there will be one indexing sequence for each beam, so if there are L beams, there will be L indexing sequences output by spatial multiplexing system 500. The presence of more outputs is represented by the ellipses in FIG. 5. The outputs 518 and 520 are then combined with reference signal S 530 to generate the various f(S+Iₖ) signals. The resultant signal may then be sent to precoding 526 where the precoding matrices Fₖ are applied. The constructed signal may then be transmitted as indicated by transmission 528. The physical signal that is ultimately transmitted is a modulated signal of the form:

X=Σₖ₌₁^{L}FₖModu(S+Iₖ)

Where:
Fₖ is the k^{th} precoding matrix that generates the k^{th} beam and
Modul(S+Iₖ) is the modulated form of (S+Iₖ).

Although in FIG. 5 the output 518, 520 of the spatial multiplexing system 500 is shown to be the indexing sequences Iₖ, the output may also be signal S with the indexing sequences Iₖ applied at the other leg of the mixer (e.g., Iₖ and S may be switched in FIG. 5).

Assuming Iₖ are known to the UE that receives the signal, the UE can identify which indexing sequence is best suited for its use.

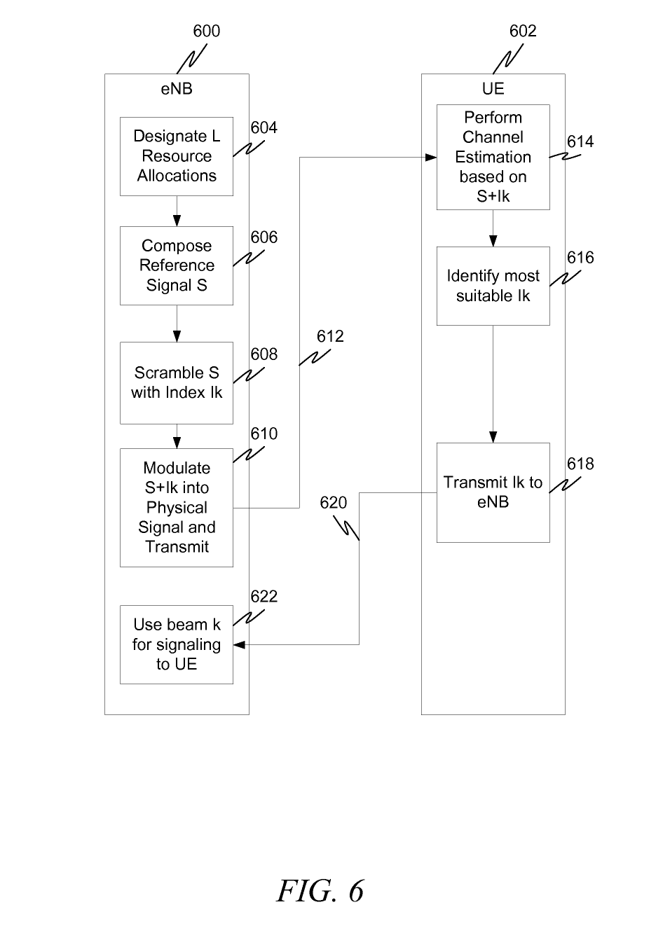

FIG. 6 illustrates an example flow diagram of a system using spatial multiplexing. The system may comprise eNB 600, which employs spatial multiplexing and UE 602, which is the UE for which the most appropriate spatial beam is to be determined

In operation 604, the system designates L resource allocations. As previously mentioned, these may be the resource allocations already designated to transmit reference signal S. In the context of this embodiment, the term resource allocations may include not only time/frequency subcarrier blocks, but may also include spatial resources (e.g., a resource allocation designating a spatial beam to be used) or other resource allocations as well. Thus, a single time/frequency subcarrier resource allocation may be used to transmit on all beams, relying on spatial diversity to reduce interference between the transmitted signals. Other signal diversity mechanisms may also be used.

A single reference signal S is composed in operation 606. As previously stated, this may be any reference signal used by the standard. In operation 608, the reference signal is scrambled with the various indexing codes, Iₖ. Finally, precoding matrices Fₖ are applied and the scrambled signal is modulated onto a physical signal and transmitted as shown in operations 610 and 612 so that each beam contains the reference signal scrambled by a different indexing code.

The above process results in the reference signal scrambled with a different indexing sequence being transmitted to UE 602 on a different spatial beam. Since the UE 602 physically resides in a particular spatial location, one of the indexing sequence scrambled reference signals will be received by UE 602, while the others will not be detectable. The worst case scenario where the UE 602 resides between two beams and can decode neither correctly will be addressed below.

In operation 614, the UE 602 performs a channel estimation calculation for each of the (S+Iₖ) signals. This is possible since the UE 602 knows each of the indexing sequences 4 as well as the expected reference signal S. The channel estimation calculation may be any calculation appropriate to the reference signal and that yields a measure of how well the UE 602 receives a signal scrambled with the corresponding indexing sequence. Representative metrics may include, but are not limited to, a SINR, a modulation and coding scheme level (e.g., a term that encompasses modulation order and code rate of a transmission), a data rate indicator, a received signal strength indicator, an error rate indicator, and the like, and combinations thereof. In one example, the UE 602 performs a Channel Quality Indicator (CQI) calculation in accordance with one of the LTE standards.

The UE 602 selects the indexing sequence 4 most suitable for use in operation 616. This may be accomplished by selecting the index corresponding to the “best” value for a given metric (highest data rate, highest SNIR, lowest error rate, etc.). In yet another example, the metric should be above a certain level of acceptability in order to select the corresponding index. If, for example, the UE 602 resides between spatial beams but nevertheless manages to decode the indices for both beams, the metric may be below some acceptable threshold. In this case, the UE 602 may select neither of the two alternatives. If combinations of metrics result in tradeoffs between two selections, the UE 602 may select the index corresponding to a sufficient set of metrics. Finally, in the case of competing metrics (e.g., two equally acceptable metrics), some sort of resolution logic may be used.

In operation 618, an indication of the selected index may be transmitted to the eNB 600. The indication may be anything that allows the eNB 600 to identify which index was selected by the UE 602.

After the eNB 600 receives the indication of which index was selected by the UE 602, the eNB 600 may then identify the beam that should be used for communication with the UE 602, as illustrated in operation 622.

Finally, with respect to FIGS. 5 and 6, it is possible to design the method to either perform the detection “in parallel” or “serially.” Transmitting all indexing sequences at the same time allows the UE 602 to do a test on all indexing sequences simultaneously. However, the eNB 600 may spread transmission of the indexing sequences out over time, frequency, and so forth as well, if desired.

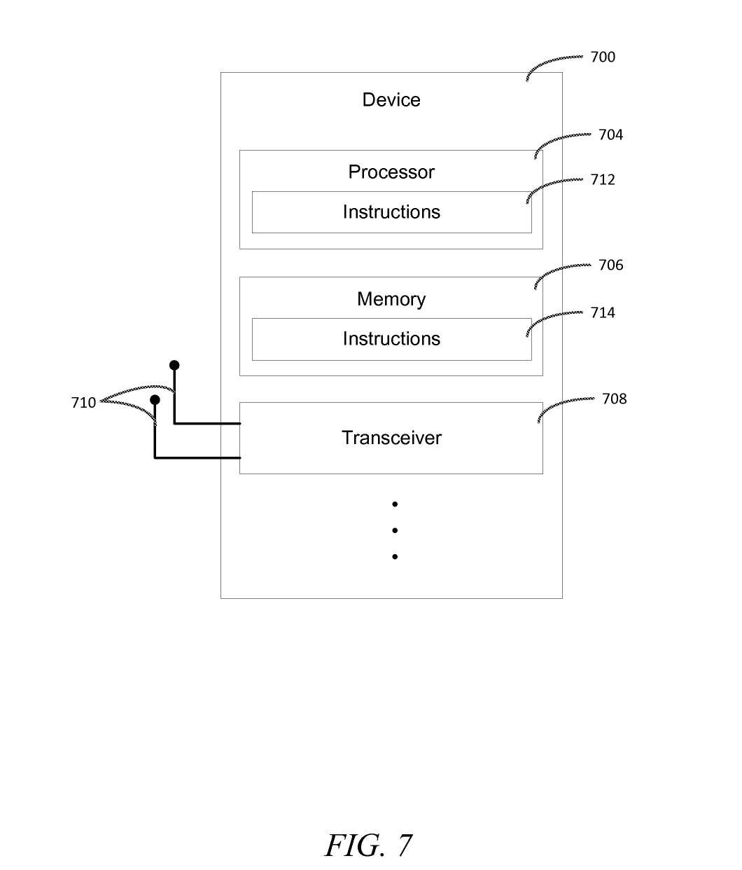

FIG. 7 illustrates a system block diagram according to some embodiments. FIG. 7 illustrates a block diagram of a device 700. Such a device could be, for example, a station such as station 102 or an eNB such as eNB 400 or 600. Such a device could also be, for example, the systems of FIG. 2 or 5 that contain the spatial multiplexing systems. Such a device could also be, for example, a UE such as UE 112, 114, 204, 402, or 602.

Device 700 may include processor 704, memory 706, transceiver 708, antennas 710, instructions 712, 714, and possibly other components (not shown).

Processor 704 comprises one or more central processing units (CPUs), graphics processing units (GPUs), accelerated processing units (APUs), or various combinations thereof. The processor 704 provides processing and control functionalities for device 700.

Memory 706 comprises one or more transient and/or static memory units configured to store instructions and data for device 700. Transceiver 708 comprises one or more transceivers including, for an appropriate station or responder, a multiple-input and multiple-output (MIMO) antenna to support MIMO communications. For device 700, transceiver 708 receives transmissions and transmits transmissions. Transceiver 708 may be coupled to antennas 710, which represent an antenna or multiple antennas, as appropriate to the device.

The instructions 712, 714 comprise one or more sets of instructions or software executed on a computing device (or machine) to cause such computing device (or machine) to perform any of the methodologies discussed herein. The instructions 712, 714 (also referred to as computer- or machine-executable instructions) may reside, completely or at least partially, within processor 704 and/or the memory 706 during execution thereof by device 700. While instructions 712 and 714 are illustrated as separate, they can be part of the same whole. The processor 704 and memory 706 also comprise machine-readable storage media.

In FIG. 7, processing and control functionalities are illustrated as being provided by processor 704 along with associated instructions 712 and 714. However, these are only examples of processing circuitry that comprise programmable logic or circuitry (e.g., as encompassed within a general-purpose processor or other programmable processor) that is temporarily configured by software or firmware to perform certain operations. In various embodiments, processing circuitry may comprise dedicated circuitry or logic that is permanently configured (e.g., within a special-purpose processor, application specific integrated circuit (ASIC), or array) to perform certain operations. It will be appreciated that a decision to implement a processing circuitry mechanically, in dedicated and permanently configured circuitry, or in temporarily configured circuitry (e.g., configured by software) may be driven by, for example, cost, time, energy-usage, package size, or other considerations.

Accordingly, the term “processing circuitry” should be understood to encompass a tangible entity, be that an entity that is physically constructed, permanently configured (e.g., hardwired), or temporarily configured (e.g., programmed) to operate in a certain manner or to perform certain operations described herein.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

The term “computer readable medium,” “machine-readable medium” and the like should be taken to include a single medium or multiple media (e.g., a centralized or distributed database, and/or associated caches and servers) that store the one or more sets of instructions. The terms shall also be taken to include any medium that is capable of storing, encoding, or carrying a set of instructions for execution by the machine and that cause the machine to perform any one or more of the methodologies of the present disclosure. The term “computer readable medium,” “machine-readable medium” shall accordingly be taken to include both “computer storage medium,” “machine storage medium” and the like (tangible sources including, solid-state memories, optical and magnetic media, or other tangible devices and carriers but excluding signals per se, carrier waves and other intangible sources) and “computer communication medium,” “machine communication medium” and the like (intangible sources including, signals per se, carrier wave signals and the like).

It will be appreciated that, for clarity purposes, the above description describes some embodiments with reference to different functional units or processors. However, it will be apparent that any suitable distribution of functionality between different functional units, processors or domains may be used without detracting from embodiments disclosed herein. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although the present embodiments have been described in connection with some embodiments, it is not intended to be limited to the specific form set forth herein. One skilled in the art would recognize that various features of the described embodiments may be combined in accordance with the disclosure. Moreover, it will be appreciated that various modifications and alterations may be made by those skilled in the art without departing from the scope of the disclosure.

The following represent various example embodiments.

### Example 1

A wireless device comprising:

at least one antenna;

transceiver circuitry coupled to the at least one antenna;

memory;

a processor coupled to the memory and transceiver circuitry; and

instructions, stored in the memory, which when executed cause the processor to:

receive, via the at least one antenna and transceiver circuitry, a spatial reference signal comprising a base reference signal and an indexing sequence of a plurality of indexing sequences;

perform a channel quality estimate for each of the plurality of indexing sequences in order to identify the indexing sequence; and

transmit an indication of the identified indexing sequence.

### Example 2

The device of example 1, wherein the channel quality estimate comprises measuring a channel quality indicator.

### Example 3

The device of example 2, wherein the channel quality indicator comprises one of: a signal to interference and noise ratio, a modulation and coding scheme level, a data rate indicator, a received signal strength indicator, and combinations thereof.

### Example 4

The device of example 1, wherein the spatial reference signal comprises the base reference signal and a plurality of indexing sequences.

### Example 5

The device of any preceding example wherein the channel quality estimate identifies the indexing sequence by:

measuring a channel quality indicator for each of the plurality of indexing sequences; and

selecting one of the plurality of indexing sequences having an associated channel quality indicator meeting a designated criteria.

### Example 6

A method comprising:

receiving, from an enhanced node B, a spatial reference signal comprising a base reference signal and an indexing sequence of a plurality of indexing sequences;

performing a channel quality estimate for each of the plurality of indexing sequences in order to identify the indexing sequence; and

transmitting an indication of the identified indexing sequence to the enhanced node B.

### Example 7

The method of example 6, wherein performing the channel quality estimate comprises measuring a channel quality indicator.

### Example 8

The method of example 7, wherein the channel quality indicator comprises one of: a signal to interference and noise ratio, a modulation and coding scheme level, a data rate indicator, a received signal strength indicator, and combinations thereof

### Example 9

The method of example 6, 7 or 8, wherein the spatial reference signal comprises the base reference signal and a plurality of indexing sequences.

### Example 10

The method of example 6, 7, 8, or 9, wherein the channel quality estimate identifies the indexing sequence by:

measuring a channel quality indicator for each of the plurality of indexing sequences; and

selecting one of the plurality of indexing sequences having an associated channel quality indicator meeting a designated criteria.

### Example 11

A wireless communication device comprising:

processing circuitry configured to:

designate a plurality of resource allocations, each of the blocks being mutually different from each other;

construct a downlink control information (DCI) message for each of the plurality of resource allocations;

build a physical downlink control channel (PDCCH) for each of the plurality of DCI messages;

cause transmission of each of the PDCCH on a separate spatial beam using the associated resource allocation.

### Example 12

The device of example 11, wherein each of the DCI messages specifies a different Physical Uplink Shared CHannel (PUSCH).

### Example 13

The device of example 11 or 12, wherein the processing circuitry is further configured to attempt to decode received information at each PUSCH based on a user equipment (UE) Cell Radio Network Temporary Identifier (C-RNTI).

### Example 14

The device of example 11, 12, or 13, wherein the processing circuitry is further configured to identify the UE as being located in a designated spatial beam when information is decoded at a designated PUSCH associated with the designated spatial beam.

### Example 15

The device of example 13 or 14, wherein the UE supports the LTE Release 8 or later standard.

### Example 16

The device of example 13 or 14, wherein the UE supports the LTE Release 10 or later standard.

### Example 17

A wireless communication device comprising:

processing circuitry configured to:

designate a resource allocation;

construct a plurality of spatial reference signals, each spatial reference signal comprising a base reference signal and an index sequence;

cause transmission of a physical signal comprising a modulated version of each spatial reference signal, each spatial reference signal being transmitted on a different one of a plurality of spatial beams.

### Example 18

The device of example 17, wherein the processing circuitry is further configured to:

receive an indication of a selected index sequence from user equipment; and

identify a spatial beam of the plurality of spatial beams to communicate with the user equipment based on the indication.

### Example 19

The device of example 17 or 18, wherein the processing circuitry is further configured to designate a plurality of resource allocations and to cause transmission of the physical signal at each of the plurality of resource allocations.

### Example 20

The device of example 17, 18, or 19, wherein the physical signal takes the form of ΣLₖ₌₁^{L}FₖModu(Iₖ+S), where Fₖ represents a k^{th} precoding matrix and Modu(Iₖ+S) represents a modulated version of the base reference signal S scrambled by a k^{th} index signal, and L is a number of the plurality of spatial beams.

### Example 21

A computer storage medium having executable instructions embodied thereon that, when executed, configure a device to:

receive a spatial reference signal comprising a base reference signal and an indexing sequence of a plurality of indexing sequences;

perform a channel quality estimate for each of the plurality of indexing sequences in order to identify the indexing sequence; and

transmit an indication of the identified indexing sequence.

### Example 22

The computer storage medium of example 21, wherein performing the channel quality estimate comprises measuring a channel quality indicator.

### Example 23

The computer storage medium of example 22, wherein the channel quality indicator comprises one of: a signal to interference and noise ratio, a modulation and coding scheme level, a data rate indicator, a received signal strength indicator, and combinations thereof.

### Example 24

The computer storage medium of example 21, 22, or 23, wherein the spatial reference signal comprises the base reference signal and a plurality of indexing sequences.

### Example 25

The computer storage medium of example 21, 22, 23, or 24, wherein the channel quality estimate identifies the indexing sequence by:

measuring a channel quality indicator for each of the plurality of indexing sequences; and

selecting one of the plurality of indexing sequences having an associated channel quality indicator meeting a designated criteria.

### Example 26

A method comprising:

designating a plurality of resource allocations, each of the blocks being mutually different from each other;

constructing a downlink control information (DCI) message for each of the plurality of resource allocations;

building a physical downlink control channel (PDCCH) for each of the plurality of DCI messages;

transmitting each of the PDCCH on a separate spatial beam using the associated resource allocation.

### Example 27

The method of example 26, wherein each of the DCI messages specifies a different Physical Uplink Shared CHannel (PUSCH).

### Example 28

The method of example 26 or 27, further comprising decoding received information at each PUSCH based on a user equipment (UE) Cell Radio Network Temporary Identifier (C-RNTI).

### Example 29

The method of example 26, 27, or 28, further comprising identifying the UE as being located in a designated spatial beam when information is decoded at a designated PUSCH associated with the designated spatial beam.

### Example 30

The method of example 28 or 29, wherein the UE supports the LTE Release 8 or later standard.

### Example 31

The device of example 28 or 29, wherein the UE supports the LTE Release 10 or later standard.

### Example 32

A method comprising:

designating a resource allocation;

constructing a plurality of spatial reference signals, each spatial reference signal comprising a base reference signal and an index sequence;

transmitting a physical signal comprising a modulated version of each spatial reference signal, each spatial reference signal being transmitted on a different one of a plurality of spatial beams.

### Example 33

The method of example 32, further comprising:

receiving an indication of a selected index sequence from user equipment; and

identifying a spatial beam of the plurality of spatial beams to communicate with the user equipment based on the indication.

### Example 34

The method of example 32 or 33, further comprising designating a plurality of resource allocations and transmitting the physical signal at each of the plurality of resource allocations.

### Example 35

The method of example 32, 33, or 34, wherein the physical signal takes the form of Σₖ₌₁^{L}FₖModu(Iₖ+S), where Fₖ represents a k^{th} precoding matrix and Modu(Iₖ+S) represents a modulated version of the base reference signal S scrambled by a k^{th} index signal, and L is a number of the plurality of spatial beams.

### Example 36

A computer storage medium having executable instructions embodied thereon that, when executed, configure a device to:

designate a plurality of resource allocations, each of the blocks being mutually different from each other;

construct a downlink control information (DCI) message for each of the plurality of resource allocations;

build a physical downlink control channel (PDCCH) for each of the plurality of DCI messages;

cause transmission of each of the PDCCH on a separate spatial beam using the associated resource allocation.

### Example 37

The computer storage medium of example 36, wherein each of the DCI messages specifies a different Physical Uplink Shared CHannel (PUSCH).

### Example 38

The computer storage medium of example 36 or 37, wherein the instructions further configure the device to attempt to decode received information at each PUSCH based on a user equipment (UE) Cell Radio Network Temporary Identifier (C-RNTI).

### Example 39

The computer storage medium of example 36, 37, or 38, wherein the instructions further configure the device to identify the UE as being located in a designated spatial beam when information is decoded at a designated PUSCH associated with the designated spatial beam.

### Example 40

The computer storage medium of example 38 or 39, wherein the UE supports the LTE Release 8 or later standard.

### Example 41

The computer storage medium of example 38 or 39, wherein the UE supports the LTE Release 10 or later standard.

### Example 42

A computer storage medium having executable instructions embodied thereon that, when executed, configure a device to:

designate a resource allocation;

construct a plurality of spatial reference signals, each spatial reference signal comprising a base reference signal and an index sequence;

cause transmission of a physical signal comprising a modulated version of each spatial reference signal, each spatial reference signal being transmitted on a different one of a plurality of spatial beams.

### Example 43

The computer storage medium of example 42, wherein the instructions further configure the device to:

receive an indication of a selected index sequence from user equipment; and

identify a spatial beam of the plurality of spatial beams to communicate with the user equipment based on the indication.

### Example 44

The computer storage medium of example 42 or 43, wherein the instructions further configure the device to designate a plurality of resource allocations and to cause transmission of the physical signal at each of the plurality of resource allocations.

### Example 45

The computer storage medium of example 42, 43, or 44, wherein the physical signal takes the form of Σₖ₌₁^{L}FₖModu(Iₖ+S), where Fₖ represents a k^{th} precoding matrix and Modu(Iₖ+S) represents a modulated version of the base reference signal S scrambled by a k^{th} index signal, and L is a number of the plurality of spatial beams.

1-20. (canceled)

21. A method performed by user equipment (UE), the method comprising:
receiving, from an enhanced node B, a spatial reference signal comprising a base reference signal and an indexing sequence of a plurality of indexing sequences;
performing a channel quality estimate for each of the plurality of indexing sequences in order to identify the indexing sequence; and
transmitting an indication of the identified indexing sequence to the enhanced node B.

22. The method of claim 21, wherein performing the channel quality estimate comprises measuring a channel quality indicator.

23. The method of claim 22, wherein the channel quality indicator comprises one of: a signal to interference and noise ratio, a modulation and coding scheme level, a data rate indicator, a received signal strength indicator, and combinations thereof.

24. The method of claim 21, wherein the spatial reference signal comprises the base reference signal and a plurality of indexing sequences.

25. The method of claim 21 wherein the channel quality estimate identifies the indexing sequence by:
measuring a channel quality indicator for each of the plurality of indexing sequences; and
selecting one of the plurality of indexing sequences having an associated channel quality indicator meeting a designated criteria.

26. An enhanced Node B (eNB) comprising:
processing circuitry configured to:
designate a plurality of resource allocations, each of the allocation being mutually different from each other;
construct a downlink control information (DCI) message for each of the plurality of resource allocations;
build a physical downlink control channel (PDCCH) for each of the plurality of DCI messages; and
cause transmission of each of the PDCCH on a separate spatial beam using the associated resource allocation.

27. The eNB of claim 26, wherein each of the DCI messages specifies a different Physical Uplink Shared CHannel (PUSCH).

28. The eNB of claim 27, wherein the processing circuitry is further configured to attempt to decode received information at each PUSCH based on a user equipment (UE) Cell Radio Network Temporary Identifier (C-RNTI).

29. The eNB of claim 28, wherein the processing circuitry is further configured to identify the UE as being located in a designated spatial beam when information is decoded at a designated PUSCH associated with the designated spatial beam.

30. The eNB of claim 28 wherein the UE supports the LTE Release 8 or later standard.

31. The eNB of claim 28 wherein the UE supports the LTE Release 10 or later standard.

32. An enhanced Node B (eNB) comprising:
processing circuitry configured to:
designate a resource allocation;
construct a plurality of spatial reference signals, each spatial reference signal comprising a base reference signal and an index sequence;
cause transmission of a physical signal comprising a modulated version of each spatial reference signal, each spatial reference signal being transmitted on a different one of a plurality of spatial beams.

33. The eNB of claim 32, wherein the processing circuitry is further configured to:
receive an indication of a selected index sequence from user equipment (UE); and
identify a spatial beam of the plurality of spatial beams to communicate with the UE based on the indication.

34. The eNB of claim 32 wherein the processing circuitry is further configured to designate a plurality of resource allocations and to cause transmission of the physical signal at each of the plurality of resource allocations.

35. The eNB of claim 34, wherein the physical signal takes the form of Σₖ₌₁^{K}FₖModu(Iₖ+S), where Fₖ represents a k^{th} precoding matrix and Modu(Iₖ+S) represents a modulated version of the base reference signal S scrambled by a k^{th} index signal, and K is a number of the plurality of spatial beams.

36. User Equipment (UE) comprising:
at least one antenna;
transceiver circuitry coupled to the at least one antenna;
memory;
a processor coupled to the memory and transceiver circuitry; and
instructions, stored in the memory, which when executed cause the processor to perform actions comprising:
receive, via the at least one antenna and transceiver circuitry, a spatial reference signal comprising a base reference signal and an indexing sequence of a plurality of indexing sequences;
perform a channel quality estimate for each of the plurality of indexing sequences in order to identify the indexing sequence; and
transmit an indication of the identified indexing sequence.

37. The UE of claim 36, wherein the channel quality estimate comprises measuring a channel quality indicator.

38. The UE of claim 37, wherein the channel quality indicator comprises one of: a signal to interference and noise ratio, a modulation and coding scheme level, a data rate indicator, a received signal strength indicator, and combinations thereof.

39. The UE of claim 36, wherein the spatial reference signal comprises the base reference signal and a plurality of indexing sequences.

40. The UE of claim 36 wherein the channel quality estimate identifies the indexing sequence by:
measuring a channel quality indicator for each of the plurality of indexing sequences; and
selecting one of the plurality of indexing sequences having an associated channel quality indicator meeting a designated criteria.
